(19) United States
(12) Patent Application Publication
(10) Pub. No.: US 2026/0074239 A1
(43) Pub. Date: Mar. 12, 2026

(54) FUEL CELL

(71) Applicant: TOYOTA JIDOSHA KABUSHIKI KAISHA, Toyota-shi (JP)

(72) Inventors: Kimihiro Tsuchiya, Fuji-shi (JP); Keiichi Okubo, Susono-shi (JP)

(73) Assignee: TOYOTA JIDOSHA KABUSHIKI KAISHA, Toyota-shi (JP)

(21) Appl. No.: 19/215,768

(22) Filed: May 22, 2025

(30) Foreign Application Priority Data
Sep. 10, 2024 (JP) 2024-156774

(51) Int. Cl. H01M 4/86; H01M 4/92; H01M 8/10; H01M 8/1004

(52) U.S. Cl. CPC H01M 4/8663; H01M 4/92; H01M 8/1004; H01M 2008/1095

(57) ABSTRACT

The present embodiment is a fuel cell including at least a membrane electrode assembly including an electrolyte membrane, an anode catalyst layer disposed on one surface of the electrolyte membrane, and a cathode catalyst layer disposed on the other surface of the electrolyte membrane, wherein the cathode catalyst layer includes at least an electrochemical oxygen reduction electrode catalyst including a catalyst metal having oxygen reduction activity and a modifier that modifies the catalyst metal, wherein the modifier is at least one selected from a nitrogen-containing cyclic organic compound and a polymer thereof, and includes a decomposition inhibitor that suppresses decomposition of the modifier in at least one selected from an electrolyte membrane, an anode catalyst layer, and a cathode catalyst layer.

### CROSS-REFERENCE TO RELATED APPLICATION

This application claims priority to Japanese Patent Application No. 2024-156774 filed on Sep. 10, 2024, incorporated herein by reference in its entirety.

### BACKGROUND

### 1. Technical Field

The present disclosure relates to a fuel cell.

### 2. Description of Related Art

Fuel cells cause hydrogen and oxygen to electrochemically react, and thereby obtain electrical power. In principle, only water is produced as a product of power generation that is performed by fuel cells. Accordingly, fuel cells have attracted attention as clean power generation systems that place little load on the global environment. A membrane electrode gas diffusion layer assembly (hereinafter, also referred to as “MEGA”) in which an electrode catalyst layer is disposed on each of both faces of an electrolyte membrane, and a gas diffusion layer is further disposed on an outer side of each electrode catalyst layer, serves as a basic unit from which fuel cells are configured. A polymer electrolyte having an ion exchange group (hereinafter, also referred to as “ionomer”) is usually used as a binder of the electrolyte membrane and the electrode catalyst layer. During operation of the fuel cell, electromotive force is obtained by supplying fuel gas containing hydrogen to the electrode catalyst layer on an anode (fuel electrode) side, and an oxidizing gas containing oxygen to the electrode catalyst layer on a cathode (air electrode) side, respectively. Oxidation reaction of hydrogen advances at the anode, reduction reaction of oxygen advances at the cathode, and the electromotive force is supplied to an external circuit. Accordingly, an oxygen reduction catalyst having oxygen reducing abilities is used for the electrode catalyst layer of the cathode. Various electrochemical oxygen reduction electrode catalysts have been developed to provide high-performance and also high-durability oxygen reduction catalysts that can be used in the electrode catalyst layer of the cathode of a fuel cell.

For example, Japanese Unexamined Patent Application Publication No. 2023-121010 (JP 2023-121010 A) describes a catalyst composition including a platinum-based catalyst and a salt that is modified by the platinum-based catalyst, in which the salt consists of a 1,3,5-triazine derivative cation represented by a General Formula (1) below, and a perfluoro-alkyl sulfonyl imide anion.

WO 2019/221156 describes an electrochemical oxygen reduction catalyst including platinum-containing nanoparticles, and at least one type that is selected from a group consisting of a melamine compound, a thiocyanurate compound, and a polymer containing the melamine compound or the thiocyanurate compound as a monomer.

WO 2021/090746 describes an electrochemical oxygen reduction catalyst including platinum-containing nanoparticles, and at least one type that is selected from a group consisting of a polymer containing a melamine compound as a monomer and a thiolmelamine compound, in which the polymer containing the melamine compound as a monomer is a polymer having a repeating unit represented by the General Formula (1), and the thiolmelamine compound is a thiolmelamine compound represented by a General Formula (2).

### SUMMARY

As described above, electrochemical oxygen reduction electrode catalysts having catalyst metals that are modified with various nitrogen-containing cyclic organic compounds or polymers thereof, which can be used in the electrode catalyst layer of the cathode of a fuel cell, have been developed. It is known that when a catalyst surface having oxygen reducing abilities is modified by a nitrogen-containing cyclic organic compound or the like, such as melamine or the like, the performance of the catalyst, and initial voltage in particular, is improved. Specifically, it is known that in a fuel cell in which this catalyst is used as a cathode (air electrode), the performance is particularly improved in a low-load region where contribution of the catalyst performance is great. Operation in the low-load range is the most fundamental operating condition, since the amount of hydrogen used as fuel is small, and operation can be performed with high efficiency.

However, it has been found that when a fuel cell using a catalyst containing a nitrogen-containing cyclic organic compound or the like as a modifier in a cathode is continuously operated in the low-load range, there is a problem in that decrease rate of voltage is high. Thus, there is room for improvement in performance related to the decrease rate of voltage in a fuel cell using a catalyst including a nitrogen-containing cyclic organic compound or the like as a modifier.

Accordingly, an object of the present disclosure is to provide a fuel cell with good voltage and a good retention rate thereof.

The present inventors have studied various means for solving the above problem, and found that the reason why the decrease rate of voltage increases in a fuel cell using a catalyst including a nitrogen-containing cyclic organic compound or the like as a modifier in a cathode, is decomposition of the modifier, and poisoning of the catalyst by decomposition products associated therewith. That is to say, it is presumable that the modifier decomposes by a process described below, and poisoning of the catalyst by the decomposition products occurs.
(1) Hydrogen peroxide is generated in a membrane electrode assembly (MEA)
(2) OH radicals are generated from the hydrogen peroxide due to Fenton's reaction
(3) Decomposition of modifiers by the OH radicals
(4) Catalyst poisoning caused by decomposition products reduces catalyst performance Accordingly, the present inventors have found that the voltage retention rate can be improved by including a decomposition inhibitor that suppresses decomposition of the modifier in the fuel cell, and thus the present disclosure has been achieved.

Therefore, an example of an aspect of the present embodiment is as follows.
1. A fuel cell, including
at least a membrane electrode assembly including an electrolyte membrane, an anode catalyst layer that is disposed on one face of the electrolyte membrane, and a cathode catalyst layer that is disposed on another face of the electrolyte membrane, in which
the cathode catalyst layer includes at least an electrochemical oxygen reduction electrode catalyst including a catalyst metal with oxygen reduction activity and a modifier that modifies the catalyst metal,
the modifier is at least one type that is selected from a nitrogen-containing cyclic organic compound and a polymer of the nitrogen-containing cyclic organic compound, and
a decomposition inhibitor that suppresses decomposition of the modifier is included in at least one selected among from the electrolyte membrane, the anode catalyst layer, and the cathode catalyst layer.
2. In the fuel cell according to 1, the decomposition inhibitor is a radical quenching agent that is a metal or metal complex, a metal salt, a metal oxide, or a metallic ion.
3. In the fuel cell according to 1 or 2, the decomposition inhibitor is at least one type of metallic ion selected from cerium ions and manganese ions.
4 In the fuel cell according to any one of 1 to 3, the nitrogen-containing cyclic organic compound is a compound according to Formula (1) below

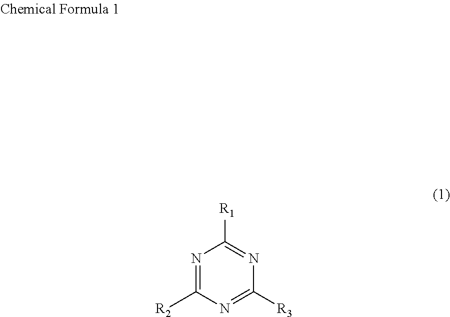

where, in Formula (1), R₁, R₂, and R₃ are each independently a hydrogen atom, a halogen atom, an amino group, a hydroxyl group, a nitrile group, an amide group, a thiol group, a sulfo group, a carboxylic acid group, a phosphoric acid group, a ketone group, an aldehyde group, an ester group, a phenyl group, a phenol group, an alkyl group, a cycloalkyl group, an alkenyl group, an alkoxy group, an alkylamino group, an alkylsulfonic acid group, a perfluoroalkyl group, an alkenylamino group, an alkenylsulfonic acid group or a perfluoroalkenyl group, in which these groups may be substituted by a fluorine atom, a chlorine atom, a bromine atom, or an iodine atom, and at least one of carbon atoms of these groups may be substituted by an oxygen atom, a sulfur atom, or a nitrogen atom.
5. In the fuel cell according to any one of 1 to 4, the catalyst metal with the oxygen reduction activity includes at least one that is selected from a group consisting of platinum, a platinum alloy, and a complex containing platinum.

According to the present disclosure, a fuel cell having a good voltage and a good retention rate can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view for explaining a configuration example of a membrane electrode gas diffusion layer assembly and a fuel cell according to the present embodiment, and is a cross-sectional view of a main part of a fuel cell 10 as an example.

### DETAILED DESCRIPTION OF EMBODIMENTS

The present embodiment is a fuel cell including at least a membrane electrode assembly including an electrolyte membrane, an anode catalyst layer disposed on one surface of the electrolyte membrane, and a cathode catalyst layer disposed on the other surface of the electrolyte membrane. The cathode catalyst layer includes at least an electrochemical oxygen reduction electrode catalyst including a catalyst metal having an oxygen reduction activity and a modifier that modifies the catalyst metal. The modifier is at least one selected from a nitrogen-containing cyclic organic compound and a polymer thereof, and includes a decomposition inhibitor that suppresses decomposition of the modifier.

According to the present embodiment, it is possible to provide a fuel cell having a good voltage and a good maintenance ratio. In the fuel cell according to the present embodiment, an electrode catalyst containing a catalyst metal having oxygen reduction activity modified with a modifier (a nitrogen-containing cyclic organic compound and/or a polymer thereof) is used in the cathode catalyst layer, whereby an excellent initial voltage can be exhibited. It has been confirmed that the nitrogen-containing cyclic organic compound or the polymer thereof as the modifier activates the catalyst metal, and by using the catalyst metal modified with the modifier at the cathode, the power generation performance (initial voltage) can be improved. On the other hand, as described above, when the catalyst modified with the modifier is used, the degradation of the modifier and poisoning of the catalyst by the accompanying decomposition product causes a problem that a decrease rate of the voltage during the operation is increased, that is, a maintenance rate of the voltage is decreased. Therefore, in the present embodiment, a decomposition inhibitor that suppresses decomposition of the modifier is included in the fuel cell such as the membrane electrode assembly or the membrane electrode gas diffusion layer assembly. As a result, the decomposition of the modifier in the cathode catalyst layer is suppressed, so that poisoning of the catalyst can be suppressed, and as a result, the maintenance ratio of the voltage can be improved.

Hereinafter, the configuration of the present embodiment will be described.

### Fuel Cell

The fuel cell according to the present embodiment includes at least a membrane electrode assembly including an electrolyte membrane, an anode catalyst layer disposed on one surface of the electrolyte membrane, and a cathode catalyst layer disposed on the other surface of the electrolyte membrane. Further, the fuel cell according to the present embodiment may include at least a membrane electrode gas diffusion layer assembly including an electrolyte membrane, an anode catalyst layer disposed on one surface of the electrolyte membrane, a cathode catalyst layer disposed on the other surface of the electrolyte membrane, an anode-side gas diffusion layer disposed on a surface of the anode catalyst layer opposite to the electrolyte membrane, and a cathode-side gas diffusion layer disposed on a surface of the cathode catalyst layer opposite to the electrolyte membrane.

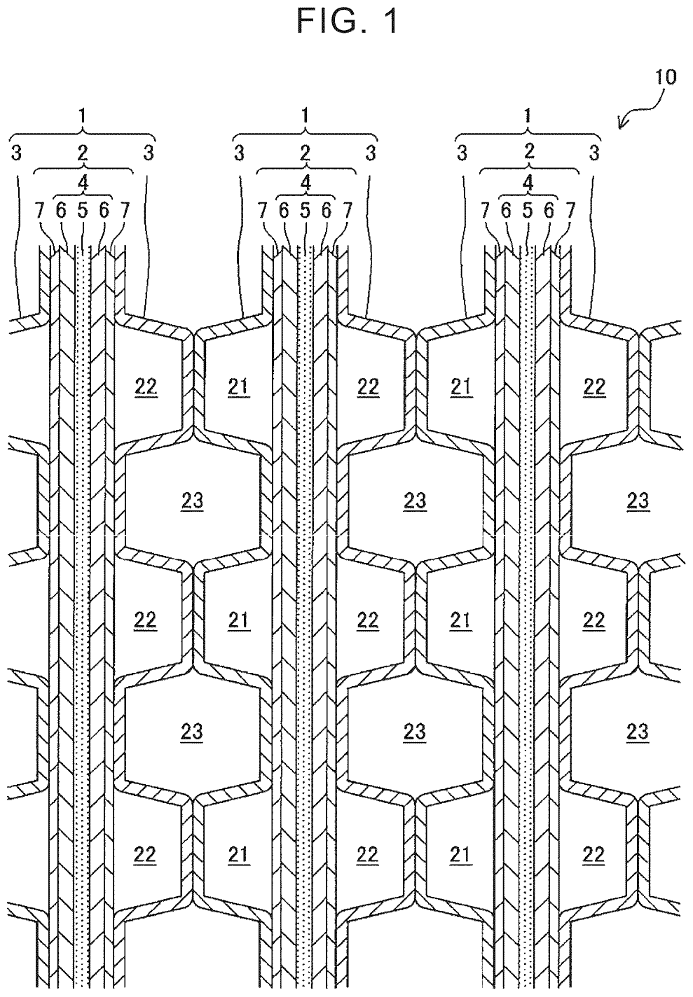

Hereinafter, a specific configuration of the membrane electrode assembly, the membrane electrode gas diffusion layer assembly, and the fuel cell (for example, a polymer electrolyte fuel cell) will be described with reference to FIG. 1.

In a fuel cell (for example, a polymer electrolyte fuel cell), a membrane electrode assembly (MEA) in which catalyst layers (electrodes) are bonded to both surfaces of an electrolyte membrane is used as a basic unit. A catalyst layer (electrode) is bonded to both surfaces of an electrolyte membrane (for example, a solid polymer electrolyte membrane). Further, a gas diffusion layer may be disposed on the outer side of the catalyst layer, and a membrane electrode gas diffusion layer assembly (MEGA) may be used as a basic unit in the fuel cell. The gas diffusion layer is for supplying a reaction gas and electrons to the catalyst layer, and carbon paper, carbon cloth, and the like are used. In addition, the catalyst layer is a portion that serves as a reaction field of the electrode reaction.

Hereinafter, a membrane electrode assembly, a membrane electrode gas diffusion layer assembly, and a solid polymer fuel cell will be described with reference to FIG. 1. FIG. 1 is a schematic cross-sectional view for explaining a configuration example of a polymer electrolyte fuel cell according to the present embodiment, and is a cross-sectional view of a main part of a fuel cell 10 as an example. A polymer electrolyte fuel cell includes a stack of unit cells composed of a power generator and a fuel cell separator disposed on both sides of the power generator. The plurality of unit cells are stacked in the stacking direction, and each unit cell is electrically connected in series. As shown in FIG. 1, a plurality of unit cells 1, which are basic units, are stacked in the fuel cell 10. Each unit cell 1 is a polymer electrolyte fuel cell that generates an electromotive force by an electrochemical reaction between an oxidizing gas (e.g., air) and a fuel gas (e.g., hydrogen). The unit cell 1 includes a membrane electrode gas diffusion layer assembly (MEGA: Membrane Electrode & Gas Diffusion Layer Assembly) 2 having gas diffusion layers (GDL: Gas Diffusion Layer) 7 disposed on both sides thereof, and separators 3 contacting MEGA2 so as to partition MEGA2. In the present embodiment, MEGA2 is sandwiched between a pair of separators 3 and 3.

MEGA2 comprises a membrane electrode assembly (MEA: Membrane Electrode Assembly) 4 and gas diffusion layers 7, 7 arranged on both sides thereof. The membrane electrode assembly 4 includes an electrolyte membrane 5 and a pair of electrodes 6 and 6 bonded to each other so as to sandwich the electrolyte membrane 5. The electrolyte membrane 5 is, for example, a proton-conductive ion exchange membrane formed of a solid polymer material. The electrode 6 includes, for example, a porous carbon material on which a catalyst such as platinum is supported. An electrode 6 disposed on one side of the electrolyte membrane 5 functions as an anode, and an electrode 6 on the other side functions as a cathode. The gas diffusion layer 7 is formed of a conductive member having gas permeability. Examples of the conductive member having gas permeability include a carbon porous body such as carbon paper or carbon cloth, and a metal porous body such as a metal mesh or a metal foam. For example, the anode electrode is composed of an anode catalyst layer and the cathode electrode is formed of a cathode catalyst layer.

The electrolyte membrane has a function of preventing the flow of electrons and gases, and transferring protons (H⁺) generated at the anode from the anode catalyst layer to the cathode catalyst layer. As the electrolyte membrane in the present embodiment, an electrolyte membrane having proton conductivity known in the art can be used. As the polymer electrolyte membrane, for example, a membrane formed of a fluororesin (Nafion (manufactured by Du Pont Co., Ltd.), Flemion (manufactured by AGC Co., Ltd.), Aciplex (manufactured by Asahi Kasei Co., Ltd.), or the like) having a sulfonate group, which is an electrolyte, can be used. In the present embodiment, the electrolyte membrane may contain a decomposition inhibitor.

The thickness of the electrolyte membrane is not particularly limited, but is, for example, 5 μm to 50 μm from the viewpoint of improving proton conductivity.

The cathode catalyst layer functions as an air electrode (oxygen electrode). The cathode catalyst layer in the present embodiment includes at least an electrochemical oxygen reduction electrode catalyst including a catalyst metal having an oxygen reduction activity and a modifier that modifies the catalyst metal. The modifier is at least one selected from a nitrogen-containing cyclic organic compound and a polymer thereof. In the present embodiment, the cathode catalyst layer may contain a decomposition inhibitor.

In the electrochemical oxygen reduction electrode catalyst, the catalyst metal may be any metal having oxygen reduction activity (oxygen reduction catalytic ability). Examples of the catalyst metal include metals such as platinum, ruthenium, iridium, rhodium, palladium, osnium, tungsten, lead, iron, chromium, cobalt, nickel, manganese, vanadium, molybdenum, gallium, aluminum, lanthanum, cerium, prascodymium, neodymium, samarium, gadolinium, and yttrium. The catalyst metal may contain the above-exemplified metal alone or as an alloy of two or more kinds. The catalyst metal may be an oxide, a nitride, a sulfide, a phosphide, or the like of the metals exemplified above. The catalyst metal preferably contains at least one selected from the group consisting of platinum, a platinum alloy, and a composite containing platinum. In the case of the composite containing platinum alloy and platinum, examples of the metal other than platinum include metals such as ruthenium, iridium, rhodium, palladium, osnium, tungsten, lead, iron, chromium, cobalt, nickel, manganese, vanadium, molybdenum, gallium, aluminum, lanthanum, cerium, prascodymium, neodymium, samarium, gadolinium, and yttrium. The composite containing a platinum alloy and platinum may contain two or more kinds of the metals exemplified above. By containing the catalyst metal exemplified above, the electrochemical oxygen reduction electrode catalyst can exhibit high proton conductivity.

The content of the catalyst metal is usually in the range from 1 to 70% by weight, preferably in the range from 18 to 65% by weight, based on the total weight of the electrochemical oxygen reduction electrode catalyst. In the case where the catalyst metal is a composite containing a platinum alloy and platinum, the content of the metal other than platinum is usually in the range of 0.11 to 60 atomic % with respect to the total mass of the catalyst metal. When the catalyst metal is contained in the content in the above range, the electrochemical oxygen reduction electrode catalyst can exhibit high proton conductivity.

The particle size of the catalyst metal is usually in the range from 1 to 100 nm.

In the electrochemical oxygen reduction electrode catalyst, the composition and content of the catalyst metal can be determined, for example, by dissolving and extracting the catalyst metal contained in the electrochemical oxygen reduction electrode catalyst, and analyzing the metal element contained in the extract by thermogravimetric analysis (IG) or radio frequency inductively coupled plasma emission spectroscopy (ICP).

In the electrochemical oxygen reduction electrode catalyst, the particle diameter of the catalyst metal can be determined, for example, by measuring the crystallite diameter by an X-ray diffraction method and calculating the average crystallite diameter. Alternatively, the particle size of the catalyst metal may be determined by measuring the particle size of 100 to 1000 catalyst metal particles by an electron microscope and calculating the average value (average particle size) thereof.

In an electrochemical oxygen reduction electrode catalyst, the catalyst metal is modified by a modifier. The state in which the catalyst metal is modified by the modifier refers to a state in which the modifier is adsorbed, supported, or brought into contact with at least a part of the catalyst metal.

In this embodiment, the modifier is at least one selected from nitrogen-containing cyclic organic compounds and polymers thereof. By using the electrochemical oxygen reduction electrode catalyst containing the modifier in the cathode catalyst layer, the power generation performance (initial voltage) can be improved, and in particular, the performance in a low-load region where the contribution of the catalyst performance is large can be improved.

The nitrogen equivalent weight of the nitrogen-containing cyclic organic compound is usually in the range of 20 to 270 g/equivalent weight, preferably in the range of 20 to 70 g/equivalent weight. The nitrogen equivalent of the nitrogen-containing cyclic organic compound may be represented by the following formula:

Nitrogen equivalent (g/equivalent)=molecular weight (g/mol) of nitrogen-containing organic compound/material weight (molN/mol) of nitrogen atoms contained in 1 molecule of nitrogen-containing organic compound

It is defined. In the case of a polymer of a nitrogen-containing cyclic organic compound, the nitrogen equivalent of the monomer contained in the polymer may be within the range exemplified above.

Examples of the nitrogen-containing cyclic organic compound include pyridine, pyrrole, thiazole, isothiazole, oxazole, isoxazole, imidazole, imidazoline, pyrazole, 1,3,5-triazine, pyrimidine, pyritazine, pyrazine, indole, quinoline, isoquinoline, brine, benzimidazole, benzoxazole, benzthiazole, tetrazole, tetrazine, triazole, carbazole, acridine, quinoxaline and quinazoline. The nitrogen-containing cyclic organic compound exemplified above is 1 or more substituted or unsubstituted amines or amino (e.g., primary amines, 2 amines, 3 amines or 4 ammonium cations), hydroxyl, halogen (e.g., fluorine, chlorine, bromine or iodine), nitrile, amide, imide, thiol, sulfonyl, carboxyl, phosphonyl, ketone, aldehyde ester, substituted or unsubstituted alkyl, substituted or unsubstituted alkenyl, substituted or unsubstituted alkynyl, substituted or unsubstituted cycloalkyl, substituted or unsubstituted cycloalkenyl, substituted or unsubstituted cycloalkynyl, substituted or unsubstituted cycloalkyl, substituted or unsubstituted heterocycloalkyl, substituted or unsubstituted cycloalkyl alkyl, substituted or unsubstituted heterocycloalkyl alkyl, substituted or unsubstituted aryl, substituted or unsubstituted arylalkyl, substituted or unsubstituted heteroaryl, substituted or unsubstituted heteroarylalkyl, substituted or unsubstituted alkoxy, substituted or unsubstituted cycloalkoxy, substituted or unsubstituted heterocycloalkoxy, substituted or unsubstituted aryloxy, substituted or unsubstituted arylalkyoxy, unsubstituted aryloxy, substituted or unsubstituted arylalkenyloxy, substituted or unsubstituted arylalkenyloxy, substituted or unsubstituted heteroaryloxy, substituted or unsubstituted heteroarylalkyoxy, or substituted or unsubstituted acyloxy, as a cyclic group. The number of carbon atoms of the group exemplified above is usually in the range of 1 to 10 in the case of a chain, and is usually in the range of 3 to 16 in the case of a ring. When the above-exemplified groups are substituted, the substituent is preferably one or more groups selected from the above-exemplified groups.

The nitrogen-containing cyclic organic compound is preferably a compound represented by the following formula (1).

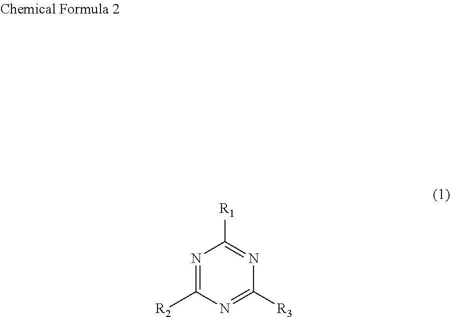

[In the formula (1), R₁, R₂ and R₃ are each independently a hydrogen atom, a halogen atom, an amino group, a hydroxyl group, a nitrile group, an amide group, a thiol group, a sulfonic acid group, a carboxylic acid group, a phosphoric acid group, a ketone group, an aldehyde group, an ester group, a phenyl group, a phenol group, an alkyl group, a cycloalkyl group, an alkenyl group, an alkoxy group, an alkylamino group, an alkylsulfonic acid group, a perfluoroalkyl group, an alkenylamino group, an alkenylsulfonic acid group, or a perfluoroalkenyl group. These groups may be substituted with a fluorine atom, a chlorine atom, a bromine atom or an iodine atom, and at least one of the carbon atoms of these groups may be substituted by an oxygen atom, a sulfur atom or a nitrogen atom.]

In the formula (1), the alkyl group may be linear or branched, and has, for example, 1 to 10 carbon atoms. The number of carbon atoms of the cycloalkyl group is, for example, 3 to 10. The alkenyl group may be linear or branched and has, for example, 2 to 10 carbon atoms. The alkoxy group may be linear or branched and has, for example, 1 to 10 carbon atoms. The alkylamino group may be a primary amino group or a secondary amino group, i.e., including —NH(alkyl) and —N(alkyl)₂, wherein each “alkyl” may be independently linear or branched, and wherein each carbon-number is independently, for example, from 1 to 10. The alkyl group of the alkylsulfonic acid group may be linear or branched and has, for example, 1 to 10 carbon atoms. The alkyl group of the perfluoroalkyl group may be linear or branched and has, for example, 1 to 10 carbon atoms. The alkenylamino group, even a primary amino group, may be a secondary amino group, i.e., —NH(alkenyl) and —N(alkenyl) 2, each of which may be independently, branched chain, even in a linear form, with their carbon numbers being, for example, from 1 to 10, respectively. The alkenyl group of the alkenylsulfonic acid group may be linear or branched and has, for example, 1 to 10 carbon atoms. The alkenyl group of the perfluoroalkenyl group may be linear or branched and has, for example, 1 to 10 carbon atoms.

The modifier is preferably melamine (1,3,5-triazine-2,4,6-triamine), ammeline, ammelide, cyanuric acid or triazine (1,2,3-triazine, 1,2,4-triazine or 1,3,5-triazine) or a derivative thereof, or a polymer thereof, and melamine or a derivative thereof (nitrogen equivalent 21 g/equivalent), ammeline, ammelide, 1,3,5-triazine or a derivative thereof (nitrogen equivalent 27 g/equivalent), thiocyanuric acid or a derivative thereof (nitrogen equivalent 59 g/equivalent), cyanuric acid or a derivative thereof (nitrogen equivalent 34 g/equivalent), 2,4,6-tris [bis(methoxymethyl)amino]-1,3,5-triazine (nitrogen equivalent 65 g/equivalent), 6-(dibutylamino)-1,3,5-triazine-2,4-dithiol (nitrogen equivalent 68 g/equivalent), 2,4-diamino-6-butylamino-1,3,5-triazine (nitrogen equivalent 30 g/equivalent) or 2,4,6-tris(pentafluorocthyl)-1,3,5-triazine (nitrogen equivalent 145 g/equivalent) or a polymer taking these as a monomer, or a copolymer such as a melamine-formaldehyde such as methylated poly(melamine-co-formaldehyde) (nitrogen equivalent 20 to 40 g/equivalent) or isobutylated poly(melamine-co-formaldehyde) (nitrogen equivalent 20 to 40 g/equivalent) or the like is preferred, and preferably is a 1,3,5-triazine, ammelide, melamine or melamine-formaldehyde copolymer.

Examples of the polymer of the nitrogen-containing cyclic organic compound include a monomer or a copolymer containing the above-exemplified nitrogen-containing cyclic organic compound as at least one monomer. In the case of the polymer of the nitrogen-containing cyclic organic compound, the degree of polymerization is preferably in the range of 1 to 10,000, and more preferably in the range of 10 to 10,000.

The polymer of the nitrogen-containing cyclic organic compound in the present embodiment is, for example, a polymer obtained by condensation polymerization of a component containing a compound of formula (1) and aldehydes such as methanal (formaldehyde), ethanal, or propanal. A preferred aldehyde is formaldehyde. The polymer is preferably a polymer obtained by condensation polymerization of melamine and formaldehyde. The method for producing the polymer is not particularly limited, and may be, for example, a known method.

The content of the modifier is usually in the range from 0.001 to 0.1, preferably in the range from 0.005 to 0.1, as a mass ratio (modifier/catalyst metal) to the mass of the catalyst metal in the electrochemical oxygen reduction electrode catalyst. The electrochemical oxygen reduction electrode catalyst can exhibit high proton conductivity by containing the modified layer in the content in the above range.

The composition and content of the modifier can be determined, for example, by dissolving and extracting the modifier contained in the electrochemical oxygen reduction electrode catalyst, and analyzing the components contained in the extract by elemental analysis, various chromatographic methods, ultraviolet-visible spectroscopy (UV-Vis), infrared spectroscopy (IR), or nuclear magnetic resonance (NMR).

In an electrochemical oxygen reduction electrode catalyst, the modifier is typically disposed on the surface of the catalyst metal, e.g., coating the surface of the catalyst metal. In this case, it is preferred that at least a part of the modifier forms a bond with the catalyst metal. Further, the modification rate of the modifier on the surface of the catalyst metal is preferably less than 28 area %, and preferably in the range of 5 to 20 area %, with respect to the total surface area of the catalyst metal. By disposing the modifier in the form described above, the electrochemical oxygen reduction electrode catalyst can exhibit high durability.

In an electrochemical oxygen reduction electrode catalyst, the modification rate of the modifier on the surface of the catalyst metal is defined as the percentage of the surface area of the catalyst metal modified with the modifier relative to the total surface area of the catalyst metal. The modification rate of the modifier on the surface of the catalyst metal can be determined, for example, by the following procedure. The modifier contained in the electrochemical oxygen reduction electrode catalyst is dissolved to obtain the catalyst metal from which the modifier has been removed. The surface area of the catalyst metal from which the modifier has been removed (i.e., the total surface area of the catalyst metal) is measured, for example, by a gas phase adsorption method or an electrochemical material adsorption method. In a similar manner, the surface area of the catalyst metal not modified with the modifier contained in the electrochemical oxygen reduction electrode catalyst is measured. The total surface area of the catalyst metal minus the surface area of the catalyst metal not modified with the modifier is the surface area of the catalyst metal modified with the modifier. From the values obtained, the modification rate of the modifier on the surface of the catalyst metal is calculated.

The electrochemical oxygen reduction electrode catalysts usually have a support on which the catalyst metal is supported. In one embodiment, the electrode catalyst is a metal-supported catalyst in which metal particles having catalytic activity are supported on a support. Carriers can include, for example, conductive carbon and oxides, and mixtures of one or more thereof. The carbon is preferably carbon black (such as acetylene black, Ketjen black, and furnace black), activated carbon, graphite, glassy carbon, graphite, graphene, carbon fiber, carbon nanotube, carbon nitride, sulfurized carbon, phosphated carbon, channel black, roller black, disk black, oil furnace black, gas furnace black, lamp black, thermal black, or bulk carbon, or a mixture of one or more thereof. The oxide is preferably titanium oxide, niobium oxide, tin oxide, tungsten oxide or molybdenum oxide, or a mixture of one or more thereof. The support is preferably carbon, and more preferably carbon black.

The carrier is preferably a carrier having pores, and is preferably a carbon carrier having pores.

As a method of supporting the catalyst metal on the support, a method conventionally used can be employed. For example, there is a method in which particulate catalyst metal is mixed with a carrier dispersion liquid in which a carrier is dispersed, filtered, washed, redispersed in ethanol or the like, and then dried by a vacuum pump or the like. After drying, if necessary, heat treatment may be performed.

The carrier may be either a primary particle or a secondary particle. The particle size of the primary particles of the carrier is usually between 5 and 5,000 nm.

In the electrochemical oxygen reduction electrode catalyst, the composition, the content, and the particle size of the support can be determined, for example, by means similar to the determination of the composition, the content, and the particle size of the catalyst metal described above.

The cathode catalyst layer may include a binder. The binder is usually a polyelectrolyte (ionomer) having ion exchange groups. Examples of the ion exchange group contained in the polymer electrolyte include a sulfonic acid group, a phosphate group, and a quaternary ammonium cation group. Examples of the polymer constituting the polymer electrolyte include polymers containing perfluorocarbon, polyether ether ketone, polybenzimidazole, and the like as main components. The binder is preferably a perfluorocarbon sulfonic acid polymer.

The ionomer is preferably an ionomer having a sulfonic acid group. Ionomers, also referred to as cation exchange resins, exist as clusters formed from ionomer molecules. The ionomer is not particularly limited, and for example, an ionomer known in the art can be used. Examples of the ionomer include fluororesin ionomers such as perfluorosulfonic acid polymers; sulfonated resin ionomers such as sulfonated polyether ketone, sulfonated polyether sulfone, sulfonated polyether ether sulfone, sulfonated polysulfone, sulfonated polysulfide, sulfonated polyphenylene; and sulfoalkylated resin ionomers such as sulfoalkylated polyether ether ketone, sulfoalkylated polyether sulfone, sulfoalkylated polyether ether sulfone, sulfoalkylated polysulfone, sulfoalkylated polysulfide, sulfoalkylated polyphenylene. Of these, fluororesin ionomers are preferred. One ionomer may be used alone or two or more ionomers may be used in combination.

The content of the electrochemical oxygen reduction electrode catalyst in the cathode catalyst layer is not particularly limited, but is, for example, 3 to 70 mass % with respect to the total mass of the catalyst layer.

The modifier may be included in the metal-supported catalyst, for example, by the following method. For example, in forming a metal-supported catalyst, a modifier may be added and mixed with a particulate catalyst metal in a carrier dispersion in which the carrier is dispersed. Therefore, in the present embodiment, the electrode catalyst is preferably a metal-supported catalyst containing a catalyst metal, a support on which the catalyst metal is supported, and the modifier. In addition, the modifier may be contained in the catalyst ink for forming the cathode catalyst layer. Specifically, the catalyst ink for forming the cathode catalyst layer may include an electrode catalyst, a binder (e.g., an ionomer), a solvent, and the modifier.

Hereinafter, a method for producing an electrochemical oxygen reduction electrode catalyst will be described. The method for producing an electrochemical oxygen reduction electrode catalyst includes a modification step, and may optionally include a preparation step and an electrode catalyst layer production step.

### Preparation Process

The step includes providing a catalyst metal and a modifier. The process also typically includes providing a carrier and a binder. Further, the step may optionally comprise providing additional materials such as solvents and substrates.

The catalyst metal, the support, and the binder prepared in this step may be any materials having the characteristics described above. For example, the catalyst metal prepared in this step may be supported on the support described above.

The modifier provided in this step comprises at least a nitrogen-containing cyclic organic compound or a polymer thereof. The modifier may be any material having the characteristics described above.

In this step, each material may be prepared by preparing a material having predetermined characteristics by itself, or may be prepared by purchasing a commercially available product or the like.

### Modification Process

The step includes mixing a catalyst metal and a modifier to modify the catalyst metal. In this step, the binder may optionally be mixed together in addition to the catalyst metal and the modifier. In this step, the decomposition inhibitor may be mixed together, if desired, in addition to the catalyst metal and the modifier.

In this step, usually the catalyst metal, the modifier and optionally the support or binder are mixed with the solvent. The solvent is not particularly limited, and any liquid can be used. Solvents can include, for example, water and alcohols, and mixtures of one or more thereof. Examples of the alcohol include methanol, ethanol, 1-propanol, 2-propanol, 2-methyl-2-propanol (tert-butyl alcohol), diacetone alcohol, ethylene glycol, and propylene glycol.

In this step, the mixing means of the material is not particularly limited. Mixing means can include, for example, ultrasonic homogenizer, jet mill, beads mill, ball mill, high share and fill mix. Specific conditions (e.g., stirring speed, stirring time, and rotation speed) of the mixing means exemplified above are not particularly limited, and can be appropriately set within an arbitrary range.

The process may optionally include a vacuum defoaming process in which the resulting mixture is defoamed under vacuum conditions. In this case, the specific conditions of the vacuum defoaming treatment (for example, pressure, treatment time, and the like) are not particularly limited, and can be appropriately set within an arbitrary range. The vacuum defoaming treatment may be performed a plurality of times.

In this step, the electrochemical oxygen reduction electrode catalyst can be obtained by removing the solvent from the resulting mixture. The removal of the solvent is not particularly limited, and may be performed by any means such as heat drying or filtration.

Alternatively, when the electrode catalyst layer manufacturing step described below is performed, the mixture obtained in this step can be used in the electrode catalyst layer manufacturing step as a catalyst ink including an electrochemical oxygen reduction electrode catalyst. In this case, the mixture obtained in this step may be used as it is, or may be used by further adding the solvent exemplified above.

By carrying out this step, the catalyst metal can be modified with a modifier.

### Electrode Catalyst Layer Manufacturing Process

The step includes applying a catalyst ink comprising the electrochemical oxygen reduction electrode catalyst obtained in the modifying step to the surface of the substrate.

The base material used in this step is not particularly limited, and any material such as polytetrafluoroethylene (PTFE), an electrolyte membrane having an ion exchange group, carbon fibers, and metallic fibers can be used.

In this step, the means for applying the catalyst ink is not particularly limited. Examples of the coating means include a die coating method, a spin coating method, a screen printing method, a doctor blade method, a squeegee method, a spray coating method and an applicator method. The specific conditions of the coating means exemplified above are not particularly limited, and can be appropriately set within an arbitrary range.

In this step, the solvent is usually removed from the catalyst ink after coating. The removal of the solvent is not particularly limited, and may be performed by any means such as heating and drying. Specific conditions of removal of the solvent (for example, temperature, pressure, treatment time, and the like) are not particularly limited, and can be appropriately set within an arbitrary range.

By carrying out this step, the electrochemical oxygen reduction electrode catalyst can be obtained in a form (electrode catalyst layer) disposed on the surface of the substrate. In this case, the film thickness of the electrode catalyst layer is usually in the range of 5 to 30 μm. The content of the catalyst metal in the electrode catalyst layer is usually 0.1 to 0.6 mg/cm² as a mass % with respect to the total area of the electrode catalyst layer.

In the present embodiment, the membrane electrode gas diffusion layer assembly includes a decomposition inhibitor that suppresses decomposition of the modifier. The modifier decomposes under the operating environment of the fuel cell, and the decomposition product poisons the catalyst, thereby increasing the rate of decrease of the voltage. Therefore, in the present embodiment, a configuration is adopted in which at least a part of the membrane electrode gas diffusion layer assembly includes a decomposition inhibitor that suppresses decomposition of the modifier. As a result, the decomposition of the modifier in the cathode catalyst layer is suppressed, so that poisoning of the catalyst can be suppressed, and as a result, the maintenance ratio of the voltage can be improved.

The decomposition inhibitor may be contained in the fuel cell, and may be contained in any of the members constituting the fuel cell. Further, it is preferably included in any member of the membrane electrode assembly, and specifically, it is preferably included in at least one selected from an electrolyte membrane, an anode catalyst layer, and a cathode catalyst layer. Further, it is preferably included in any member of the membrane electrode gas diffusion layer assembly, and is preferably included in at least one selected from, for example, an electrolyte membrane, an anode catalyst layer, a cathode catalyst layer, an anode-side gas diffusion layer, and a cathode-side gas diffusion layer.

For example, when the decomposition inhibitor is added to the anode catalyst layer or the cathode catalyst layer, the decomposition inhibitor may be included in the anode catalyst layer or the cathode catalyst layer by adding a predetermined amount of a decomposition inhibitor (for example, cerium nitrate) together with the metal-supported carrier, the binder, the modifier, and the solvent in the catalyst ink preparation step. For example, when the decomposition inhibitor is added to the electrolyte membrane, the decomposition inhibitor can be included in the electrolyte membrane by immersing the electrolyte membrane in a solution (e.g., an aqueous solution) of the decomposition inhibitor (e.g., cerium nitrate) at a predetermined concentration for a predetermined time. When added to the anode-side gas diffusion layer or the cathode-side gas diffusion layer, a predetermined amount of a decomposition inhibitor (for example, cerium oxide) is added to MPL (Micro Porous Layer) paste, whereby the decomposition inhibitor can be included in the gas diffusion layer.

The decomposition inhibitor is, for example, a radical quenching agent which is a metal or metal complex, a metal salt, a metal oxide or a metallic ion. The radical quenching agent includes at least one metallic ion selected from cerium ions and manganese ions. Cerium and manganese ions function as radical quenching agents. A technique for detoxifying hydrogen peroxide radicals generated during power generation of a fuel cell by including a radical quenching agent such as cerium ions in a membrane electrode gas diffusion layer assembly has been proposed. Detoxification of hydrogen peroxide radicals is, for example, the reaction of hydrogen peroxide radicals to water. The radical quenching agent can facilitate the conversion of hydroxide radicals generated from hydrogen peroxide into hydroxide ions, and can suppress the decomposition of the decomposition inhibitor. For example, the reaction of hydroxide radicals with cerium ions to hydroxide ions is as follows: Ce³⁺+·OH(hydroxyl radical)→Ce⁴⁺+OH⁻(hydroxide ion)

The cerium ion may be +3 valent or +4 valent. The manganese ion may be +3 valent or +4 valent.

The cerium salt for obtaining cerium ions is not particularly limited, and examples thereof include cerium nitrate, cerium carbonate, cerium acetate, cerium chloride, cerium sulfate, diammonium cerium nitrate, and cerium tetraammonium sulfate. As the cerium salt, one kind may be used alone, or two or more kinds may be used in combination. The cerium salt may be an organometallic complex salt. Examples of the organometallic complex salt include cerium acetylacetonate and the like.

The manganese salt for obtaining the manganese ion is not particularly limited, and examples thereof include manganese nitrate, manganese carbonate, manganese acetate, manganese chloride, and manganese sulfate. One manganese salt may be used alone, or two or more manganese salts may be used in combination.

When the electrolyte membrane (in particular, the solid polymer electrolyte membrane) contains a metallic ion as a decomposition inhibitor, an electrolyte membrane containing a metallic ion can be obtained by, for example, the following method.
(1) A method of ion-exchanging a group such as a sulfonic acid group into a metallic ion by immersing a solid polymer electrolyte membrane in a solution containing a metallic ion.
(2) A method in which a compound containing a metallic ion (for example, a cerium salt) is added to a dispersion of a polymer electrolyte, and a group such as a sulfonic acid group is ion-exchanged with a metallic ion, and then a film is formed by coating.

The content of the decomposition inhibitor is not particularly limited, and is, for example, 0.1 to 20 μg/cm². Specifically, the content of the decomposition inhibitor in the electrolyte membrane, the anode catalyst layer, the cathode catalyst layer, the anode-side gas diffusion layer, or the cathode-side gas diffusion layer is not particularly limited, and is, for example, 0.1 to 20 μg/cm².

The anode catalyst layer functions as a fuel electrode, i.e., a hydrogen electrode.

The anode catalyst layer includes at least an electrode catalyst and a binder. The binder is preferably an ionomer, and is preferably an ionomer having a sulfonic acid group. Examples of the ionomer having a sulfonic acid group include those described above. In the present embodiment, the anode catalyst layer may contain a decomposition inhibitor. In one embodiment, the anode catalyst layer may include a decomposition inhibitor in addition to the electrode catalyst and the ionomer.

The electrode catalyst is not particularly limited, and may be, for example, a metal-supported catalyst in which metal particles having catalytic activity are supported on a support.

The ionomer having a sulfonic acid group is not particularly limited, and examples thereof include a polymer electrolyte resin having ion conductivity such as a perfluorosulfonic acid ionomer. Specific examples of the ionomer having a sulfonic acid group include Nafion, Aquavion (Solvay Corporation), and the like.

As described above, in the fuel cell according to the present embodiment, the membrane electrode gas diffusion layer assembly may be used as a basic unit. The gas diffusion layer serves to uniformly supply the gas (oxidizing gas or fuel gas) supplied from the separator to the catalyst layer. It is also desired that the gas diffusion layer has excellent conductivity as a conductive path of electrons between the catalyst layer and the separator.

The anode-side gas diffusion layer is disposed on a surface of the anode catalyst layer opposite to the electrolyte membrane, and the cathode-side gas diffusion layer is disposed on a surface of the cathode catalyst layer opposite to the electrolyte membrane.

The gas diffusion layer may include, but is not limited to, a gas diffusion layer substrate, and MPL (Micro Porous Layer). The gas diffusion layers are not particularly limited, and may include, for example, a conductive porous base material such as a carbon fiber nonwoven fabric or a carbon fiber woven fabric, and a MPL containing conductive particles and a polymer resin as main components. The conductive porous substrate is made of, for example, carbon fiber. The gas diffusion layer base material may be a metal porous body such as a metal mesh or a metal foam. MPL may be formed to include, for example, conductive carbon-particles and a polymer resin (e.g., a water-repellent resin). Examples of the water-repellent resin include polytetrafluorocthylene, polyethylene, and polypropylene. MPL may be formed by coating a gas diffusion layer base material with a MPL paste in which conductive carbon-particles, a polymer resin (e.g., a water-repellent resin), a binder, and solvents such as water are mixed. MPL may optionally be formed through a drying step or a baking step after application. The two gas diffusion layers (the cathode-side gas diffusion layer and the anode-side gas diffusion layer) are disposed on both surfaces of the membrane electrode assembly so that MPL is in contact with the membrane electrode assembly.

In the present embodiment, the decomposition inhibitor may be included in MPL. For example, the decomposition inhibitor may be included in MPL by including the decomposition inhibitor in the MPL paste.

The thickness of the gas diffusion layer is, for example, 50 to 1000 μm, preferably 100 to 500 μm.

### Method for Manufacturing Membrane Electrode Gas Diffusion Layer Assembly

The catalyst layer can be formed by, for example, a step of preparing a catalyst ink (for example, a solid content concentration of about 10%) containing an electrode catalyst or the like, a step of applying the catalyst ink to the surface of the substrate and volatilizing a solvent in the coating film to form a catalyst layer on the surface of the substrate, and a step of transferring the catalyst layer on the surface of the substrate to the electrolyte membrane. In addition, the catalyst layer can be formed by a method in which the catalyst ink is directly applied to the electrolyte membrane instead of the base material. By forming the cathode catalyst layer and the anode catalyst layer on the electrolyte membrane, a membrane electrode assembly can be produced. In addition, by arranging two gas diffusion layers (cathode-side gas diffusion layer and anode-side gas diffusion layer) on both surfaces of the membrane electrode assembly, the membrane electrode gas diffusion layer assembly can be manufactured. In the present embodiment, the cathode catalyst layer is formed to contain the modifier. The decomposition inhibitor may be included in the catalyst ink for forming the anode catalyst layer and/or the cathode catalyst layer.

Examples of the method for applying the catalyst ink include a spray method, a blade coating method using a doctor blade or an applicator, a die coating method, a reverse roll coater method, and an intermittent die coating method.

As described above, according to the present embodiment, it is possible to provide a fuel cell having a good voltage and a good maintenance ratio. Such a fuel cell can be suitably used, for example, as a fuel cell for an automobile, a marine vessel, or a railway vehicle.

Hereinafter, the present embodiment will be described with reference to examples.

### Preparation of Electrode Catalyst 1 (Containing Modifier)

A metal supported catalyst (electrode catalyst 1) containing platinum cobalt alloy particles (metal ratio 0.13 atm % other than platinum, mean particle diameter: 4 nm from 3) as a catalyst metal, a polymer containing 1,3,5-triazine-2,4,6-triamine as a modifier as a monomer (trade name: poly(melamic-co-formaldehyde) methylated solution, manufactured by Merck Co., Ltd.), and carbon (commercially available acetylene black) as a support was prepared (metal loading ratio: 40 wt %).

The ratio of the mass of the modifier to the mass of the carbon support (modifier mass/carrier mass) calculated from the charge was 0.02.

Preparation of Electrode Catalyst 2 (without Modifier)

A metal supported catalyst (electrode catalyst 2) containing platinum cobalt alloy particles (metal ratio 0.13 atm % other than platinum, mean particle diameter: 4 nm from 3) as a catalyst metal and carbon (commercially available acetylene black) as a support was prepared (metal supported ratio: 40 wt %).

### Preparation of Catalyst Inks for Cathodes (Containing Modifiers and Decomposition Inhibitor)

The electrode catalyst 1 (containing a modifier) was dispersed in an ionomer solution (NafionDE2020) containing water, cerium nitrate as a decomposition inhibitor, and ethanol using a bead mill to prepare a cathode catalyst ink (containing a modifier and a decomposition inhibitor). The water/alcohol weight ratio in the catalyst ink was about 1.

### Preparation of Catalyst Ink for Cathode (Containing Modifier)

Cathode catalyst ink (containing modifier) was prepared by the same method as described in [Preparation of Cathode Catalyst Ink (Containing Modifier and Degradation Inhibitor)] except that cerium nitrate as a decomposition inhibitor was not added.

### Preparation of Catalyst Ink for Cathode (−)

Cathode catalyst ink (−) was prepared in the same manner as described in [Preparation of Cathode Catalyst Ink (Containing Modifier and Degradation Inhibitor)] except that electrode catalyst 2 (Containing Modifier) was added instead of electrode catalyst 1 (Containing Modifier) and cerium nitrate as decomposition inhibitor was not added.

### Preparation of Catalyst Ink for Anode (Containing Decomposition Inhibitor)

As the electrode catalyst, a platinum-supported carbon catalyst (TEC10E30E, 30% platinum-supported carbon, manufactured by Tanaka Kiyoshi Kogyo Co., Ltd.) was used. The electrode catalyst was dispersed in an ionomer solution (DE2020) containing water, cerium nitrate as a decomposition inhibitor, ethanol, and Nafion® to prepare an anode catalyst ink (containing a decomposition inhibitor).

### Preparation of Catalyst Ink for Anode (−)

The anode catalyst ink (−) was prepared in the same manner as described in [Preparation of Catalyst Ink for Anode (Containing Decomposition Inhibitor)] except that cerium nitrate was not added as the decomposition inhibitor.

### Preparation of Electrolyte Membrane (Containing Decomposition Inhibitor)

The Nafion® membrane (NR211) was immersed in an aqueous cerium nitrate solution to prepare an electrolyte membrane (containing a decomposition inhibitor).

### Preparation of Electrolyte Membrane (−)

A Nafion® membrane (NR211) was used as the electrolyte membrane (−).

### Preparation of Cathode-Side Gas Diffusion Layer (Containing Decomposition Inhibitor)

Carbon particles, cerium nitrate as a decomposition inhibitor, MPL pastes containing polytetrafluoroethylene and solvents were coated on the carbon paper made of carbon fiber and dried to prepare a cathode-side gas diffusion layer (containing a decomposition inhibitor).

### Preparation of Cathode-Side Gas Diffusion Layer (−)

The cathode-side gas diffusion layer (−) was prepared by the same method as described in [Preparation of cathode-side gas diffusion layer (containing decomposition inhibitor)] except that cerium nitrate as the decomposition inhibitor was not added.

### Preparation of Anode-Side Gas Diffusion Layer (Containing Decomposition Inhibitor)

MPL pastes containing carbon particles, cerium nitrate as a decomposition inhibitor, polytetrafluoroethylene, and solvents were coated on the carbon paper made of carbon fibers and dried to prepare an anode-side gas diffusion layer (containing a decomposition inhibitor).

### Preparation of Anode-Side Gas Diffusion Layer (−)

The anode-side gas diffusion layer (−) was prepared by the same method as described in [Preparation of anode-side gas diffusion layer (containing decomposition inhibitor)] except that cerium nitrate as the decomposition inhibitor was not added.

### First Embodiment

### Formation of a Cathode Catalyst Layer

Cathode catalyst ink (containing a modifier and a decomposition inhibitor) was coated on the polytetrafluoroethylene sheet and dried to form a cathode catalyst layer. Pt basis weight of the cathode catalyst layer was 0.2 mg/cm², and the weight-ratio (I/C) of the ionomer to the support was 1.0. The cerium nitrate level was 3 μg/cm².

### Formation of the Anode Catalyst Layer

The anode catalyst ink (−) was coated on a polytetrafluoroethylene sheet and dried to form an anode catalyst layer. Pt basis weight of the anode catalyst layer was 0.1 mg/cm². The weight fraction (I/C) of ionomer to carbon was 1.0.

### Preparation of Membrane Electrode Gas Diffusion Layer Assembly

Each of the obtained cathode catalyst layer and anode catalyst layer was thermally transferred to both surfaces of the electrolyte membrane (−) to prepare a membrane electrode assembly. Thermal transfer was performed at 140° C., 50 kgf/cm² (4.90 Pa) and 5 min. The electrode area of the membrane electrode assembly was 1 cm×1 cm (1 cm²). The membrane electrode assembly was sandwiched between the cathode-side gas diffusion layer (−) and the anode-side gas diffusion layer (−) so that MPL was on the membrane electrode assembly side, and a membrane electrode gas diffusion layer assembly was formed to form a test cell E1.

### Second Embodiment

A membrane electrode gas diffusion layer assembly was prepared in the same manner as in Example 1, except that the catalyst ink for the cathode (containing a modifier), the catalyst ink for the anode (containing a decomposition inhibitor), the electrolyte membrane (−), the cathode-side gas diffusion layer (−), and the anode-side gas diffusion layer (−) were used, and a test cell E2 was obtained.

### Example 3

A membrane electrode gas diffusion layer assembly was prepared in the same manner as in Example 1, except that the cathode catalyst ink (containing a modifier), the anode catalyst ink (−), the electrolyte membrane (containing a decomposition inhibitor), the cathode side gas diffusion layer (−), and the anode side gas diffusion layer (−) were used, and a test cell E3 was obtained.

### Example 4

A membrane electrode gas diffusion layer assembly was prepared in the same manner as in Example 1, except that the cathode catalyst ink (containing a modifier), the anode catalyst ink (−), the electrolyte membrane (−), the cathode side gas diffusion layer (−), and the anode side gas diffusion layer (containing a decomposition inhibitor) were used, and a test cell E4 was obtained.

### Example 5

A membrane electrode gas diffusion layer assembly was prepared in the same manner as in Example 1, except that the cathode catalyst ink (containing a modifier), the anode catalyst ink (−), the electrolyte membrane (−), the cathode side gas diffusion layer (containing a decomposition inhibitor), and the anode side gas diffusion layer (−) were used, and a test cell E5 was obtained.

### Comparative Example 1

A membrane electrode gas diffusion layer assembly was prepared in the same manner as in Example 1, except that the cathode catalyst ink (−), the anode catalyst ink (−), the electrolyte membrane (−), the cathode side gas diffusion layer (−), and the anode side gas diffusion layer (−) were used, and a test cell C1 was obtained.

### Comparative Example 2

A membrane electrode gas diffusion layer assembly was prepared in the same manner as in Example 1, except that the cathode catalyst ink (−), the anode catalyst ink (−), the electrolyte membrane (including the decomposition inhibitor), the cathode side gas diffusion layer (−), and the anode side gas diffusion layer (−) were used, and a test cell C2 was obtained.

### Comparative Example 3

A membrane electrode gas diffusion layer assembly was prepared in the same manner as in Example 1, except that the cathode catalyst ink (containing a modifier), the anode catalyst ink (−), the electrolyte membrane (−), the cathode side gas diffusion layer (−), and the anode side gas diffusion layer (−) were used, and a test cell C3 was obtained.

### Performance Evaluation

Cell evaluations were performed using a membrane electrode gas diffusion layer assembly (electrode area: 1 cm²). At low humidification conditions (80° C., 30% RH), air was supplied to the cathode, hydrogen was supplied to the cathode, and 2.0 L/min was supplied to the anode at pressure: 150 kPa. The holding was started in 0.2 A/cm², and the voltage immediately after was taken as the initial performance (V), and the voltage after 1 hour was taken as the after-durability performance (V). The results are given in Table 1.

TABLE 1

| | | Ce | | | | |
|---|---|---|---|---|---|---|
| | Modifier Addition | Amount | | Initial | | |
| | in Cathode Catalyst | added | | performance | Durability | Maintenance |
| | Layer (M/C) | (μg/cm²) | Addition position | [V] | [V] | rate [%] |
| Example | 0.02 | 3 | Cathode catalyst layer | 0.821 | 0.780 | 95.0 |
| Example | 0.02 | 3 | Anode catalyst layer | 0.821 | 0.782 | 95.2 |
| Example | 0.02 | 3 | Electrolyte membrane | 0.822 | 0.790 | 96.1 |
| Example | 0.02 | 3 | Anode-side gas | 0.822 | 0.770 | 93.7 |
| 4 | | | diffusion layer | | | |
| Example | 0.02 | 3 | Cathode-side gas | 0.821 | 0.765 | 93.2 |
| 5 | | | diffusion layer | | | |
| Comparat | — | — | — | 0.801 | 0.751 | 93.8 |
| Comparat | — | 3 | Electrolyte membrane | 0.799 | 0.755 | 94.5 |
| Comparat | 0.02 | — | — | 0.820 | 0.638 | 77.8 |

The upper limit value and/or the lower limit value of the numerical range described in the present specification can be arbitrarily combined to define a preferable range. For example, the upper limit value and the lower limit value of the numerical range can be arbitrarily combined to define a preferable range, the upper limit value of the numerical range can be arbitrarily combined to define a preferable range, and the lower limit value of the numerical range can be arbitrarily combined to define a preferable range.

Although the present embodiment has been described in detail above, the specific configuration is not limited to this embodiment, and even if there are design changes within a range not departing from the gist of the present disclosure, they are included in the present disclosure.

What is claimed is:

1. A fuel cell, comprising:
at least a membrane electrode assembly including an electrolyte membrane, an anode catalyst layer that is disposed on one face of the electrolyte membrane, and a cathode catalyst layer that is disposed on another face of the electrolyte membrane, wherein
the cathode catalyst layer includes at least an electrochemical oxygen reduction electrode catalyst including a catalyst metal with oxygen reduction activity and a modifier that modifies the catalyst metal,
the modifier is at least one type that is selected from a nitrogen-containing cyclic organic compound and a polymer of the nitrogen-containing cyclic organic compound, and
a decomposition inhibitor that suppresses decomposition of the modifier is included in at least one selected among from the electrolyte membrane, the anode catalyst layer, and the cathode catalyst layer.

2. The fuel cell according to claim 1, wherein the decomposition inhibitor is a radical quenching agent that is a metal or metal complex, a metal salt, a metal oxide, or a metallic ion.

3. The fuel cell according to claim 1, wherein the decomposition inhibitor is at least one type of metallic ion selected from cerium ions and manganese ions.

4. The fuel cell according to claim 1, wherein
the nitrogen-containing cyclic organic compound is a compound according to Formula (1) below 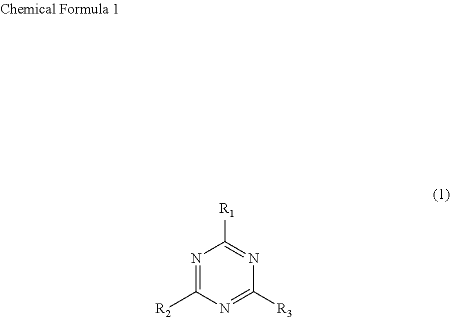
where, in Formula (1), R1, R2, and R3 are each independently a hydrogen atom, a halogen atom, an amino group, a hydroxyl group, a nitrile group, an amide group, a thiol group, a sulfo group, a carboxylic acid group, a phosphoric acid group, a ketone group, an aldehyde group, an ester group, a phenyl group, a phenol group, an alkyl group, a cycloalkyl group, an alkenyl group, an alkoxy group, an alkylamino group, an alkylsulfonic acid group, a perfluoroalkyl group, an alkenylamino group, an alkenylsulfonic acid group or a perfluoroalkenyl group, in which these groups may be substituted by a fluorine atom, a chlorine atom, a bromine atom, or an iodine atom, and at least one of carbon atoms of these groups may be substituted by an oxygen atom, a sulfur atom, or a nitrogen atom.

5. The fuel cell according to claim 1, wherein the catalyst metal with oxygen reduction activity includes at least one that is selected from a group consisting of platinum, a platinum alloy, and a complex containing platinum.
